(19) United States
(12) Patent Application Publication
(10) Pub. No.: US 2026/0280049 A1
(43) Pub. Date: Sep. 17, 2026

(54) ELECTRODE ASSEMBLY, MANUFACTURING METHOD THEREOF, AND CYLINDRICAL SECONDARY BATTERY INCLUDING THE SAME

(71) Applicant: SK ON CO., LTD., Seoul (KR)

(72) Inventor: Yoo Jung HUR, Daejeon (KR)

(21) Appl. No.: 19/530,390

(22) Filed: Feb. 5, 2026

(30) Foreign Application Priority Data
Mar. 17, 2025 (KR) 10-2025-0034105

(51) Int. Cl. H01M 50/46; H01M 10/04; H01M 50/403; H01M 50/474; H01M 50/486

(52) U.S. Cl. CPC H01M 50/461; H01M 10/0422; H01M 10/0431; H01M 50/403; H01M 50/474; H01M 50/486

(57) ABSTRACT

An electrode assembly includes a positive electrode, a negative electrode, and a separator interposed therebetween in a thickness direction and wound in a length direction with respect to a winding center, wherein the positive electrode includes a positive electrode uncoated portion protruding at one width-directional end portion, the electrode assembly includes a first adhesive layer and a second adhesive layer at one width-directional end portion, the first adhesive layer is disposed between the positive electrode uncoated portion and the separator, and the second adhesive layer is disposed between one width-directional end portion of the negative electrode and the separator.

### CROSS-REFERENCE TO RELATED APPLICATION(S)

This patent document claims the priority and benefits of Korean Patent Application No. 10-2025-0034105 filed on March 17, 2025, the disclosure of which is incorporated herein by reference in its entirety.

### TECHNICAL FIELD

The disclosure and implementations disclosed in this patent document generally relate to an electrode assembly, a manufacturing method thereof, and a cylindrical secondary battery including the same.

### BACKGROUND

Secondary batteries are rechargeable and dischargeable energy storage devices. Secondary batteries have been widely used in various devices powered by electricity. For example, secondary batteries have been utilized as energy storage devices in a variety of devices, from small devices, such as mobile phones, laptops, and tablets, to large devices, such as vehicles and aircraft. Recently, secondary batteries have been actively explored for use as a vehicle power source.

Secondary batteries may be classified into lead-acid batteries, nickel-cadmium batteries, nickel-metal hydride batteries, and lithium-ion batteries, depending on the electrode material. Thereamong, lithium-ion batteries may achieve relatively high voltage and capacity, as compared to other types of secondary batteries. Consequently, lithium-ion batteries have been widely used in applications requiring high-density energy storage, such as vehicle battery packs.

The secondary battery may include a cathode (or positive electrode), an anode (or negative electrode), a separator, and an electrolyte and may be manufactured as pouch-type, prismatic, or cylindrical batteries depending on the type and shape of the case accommodating the cathode, the anode, the separator, and the electrolyte.

### SUMMARY

The present disclosure may be implemented in some embodiments to prevent an internal short circuit in an electrode assembly included in a cylindrical secondary battery.

The present disclosure may be implemented in some embodiments to manufacture a cylindrical secondary battery having excellent processability.

The electrode assembly, the manufacturing method thereof, and the cylindrical secondary battery including the same according to the present disclosure may be widely applied to devices within green technology fields, such as electric vehicles and battery charging stations. Furthermore, the electrode assembly, the manufacturing method thereof, and the cylindrical secondary battery including the same according to the present disclosure may be used in eco-friendly electric vehicles, hybrid vehicles, and the like for preventing climate change by suppressing air pollution and greenhouse gas emissions.

In some embodiments of the present disclosure, an electrode assembly includes a positive electrode, a negative electrode, and a separator interposed therebetween in a thickness direction and wound in a length direction with respect to a winding center, wherein the positive electrode includes a positive electrode uncoated portion protruding at one width-directional end portion, the electrode assembly includes a first adhesive layer and a second adhesive layer at one width-directional end portion, the first adhesive layer is disposed between the positive electrode uncoated portion and the separator, and the second adhesive layer is disposed between one width-directional end portion of the negative electrode and the separator.

The one width-directional end portion of the negative electrode of the electrode assembly may be surrounded by the second adhesive layer and the separator disposed on both sides of the negative electrode.

The first adhesive layer and the second adhesive layer may each include at least one heat-fusible binder selected from the group consisting of polyvinylidene difluoride (PVDF), polyacrylonitrile (PAN), polybutylacrylate (PBA), polyethylhexylacrylate (PHEA), and polyacrylamide (PAAm).

The positive electrode uncoated portion may be bent radially toward a winding center of the electrode assembly at a predetermined first point.

The separator may be bent radially toward the winding center of the electrode assembly at a predetermined second point.

The first point may be located further outwardly in the width direction from the electrode assembly, as compared to the second point.

In some embodiments of the present disclosure, a method of manufacturing an electrode assembly includes: assembling a positive electrode, a negative electrode, and a separator interposed therebetween in a thickness direction to form an electrode assembly; applying a heat-fusible binder to one width-directional end portion of the electrode assembly; winding the electrode assembly, to which the heat-fusible binder has been applied, in the length direction with respect to a winding center; and heating the heat-fusible binder to form a first adhesive layer and a second adhesive layer at one width-directional end portion of the electrode assembly, wherein the positive electrode includes a positive electrode uncoated portion protruding from one width-directional end portion, the first adhesive layer may be disposed between the positive electrode uncoated portion and the separator, and the second adhesive layer may be disposed between one width-directional end portion of the negative electrode and the separator.

When applying the heat-fusible binder, the heat-fusible binder may be applied to cover one width-directional end portion of the separator.

An application width of the heat-fusible binder may be 2 to 10 mm.

The method may further include: bending the positive electrode uncoated portion and the separator at a predetermined bend point.

The bending of the positive electrode uncoated portion and the separator may be carried out simultaneously with heating of the heat-fusible binder.

A heating temperature of the heat-fusible binder may be 110 to 130°C.

In some embodiments of the present disclosure, a cylindrical secondary battery includes the electrode assembly according to any one of the embodiments described above.

### BRIEF DESCRIPTION OF DRAWINGS

Certain aspects, features, and advantages of the present disclosure are illustrated by the following detailed description with reference to the accompanying drawings.

FIG. 1 is a cross-sectional view illustrating an electrode assembly according to an embodiment of the present disclosure;

FIG. 2 is a perspective view illustrating an electrode assembly according to an embodiment of the present disclosure;

FIG. 3 is a plan view illustrating a configuration of a positive electrode according to an embodiment of the present disclosure, viewed in the thickness direction;

FIG. 4 is a cross-sectional view illustrating a configuration of a positive electrode uncoated portion of the electrode assembly of FIG. 1, bent radially toward the winding center;

FIG. 5 is a perspective view illustrating a configuration of the positive electrode uncoated portion of the electrode assembly of FIG. 4, bent radially toward the winding center;

FIG. 6 is a cross-sectional view illustrating a configuration in which a positive electrode current collector is connected to the bent positive electrode uncoated portion of the electrode assembly of FIG. 4;

FIG. 7 is a cross-sectional view illustrating a configuration in which an internal short circuit occurs in an electrode assembly according to an embodiment of the present disclosure;

FIG. 8 is a cross-sectional view illustrating a configuration in which a heat-fusible binder is applied to the electrode assembly of FIG. 1;

FIG. 9 is a cross-sectional view illustrating a configuration in which a heat-fusible binder is applied to the electrode assembly of FIG. 2;

FIG. 10 is a cross-sectional view illustrating a configuration in which a positive electrode uncoated portion of the electrode assembly of FIG. 8 is bent radially toward the winding center; and

FIG. 11 is an exploded perspective view illustrating a cylindrical secondary battery according to an embodiment of the present disclosure.

### DETAILED DESCRIPTION

The same reference numerals or symbols respectively illustrated in the attached drawings denote parts or elements that actually perform the same functions. For convenience of description and understanding, the parts or elements will be described using the same reference numerals or symbols even in different embodiments. In other words, although elements having the same reference numerals are all illustrated in a plurality of drawings, the plurality of drawings do not mean an embodiment.

As used herein, the singular forms are intended to include the plural forms as well, unless the context clearly indicates otherwise. It will be further understood that the terms “comprises,” “comprising,” etc. when used in this specification, specify the presence of stated features, integers, steps, operations, elements, and/or components, but do not preclude the presence or addition of one or more other features, integers, steps, operations, elements, components, and/or groups thereof.

In addition, in the present specification, the expressions, such as an upper side, a lower side, a side face, a rear surface, and the like, are described based on the drawings and may be expressed differently when the direction of the corresponding object is changed.

In this specification, a secondary battery may encompass a rechargeable battery. For example, the secondary battery may be a lithium ion battery.

The terms including ordinal numbers, such as ‘first,’ ‘second,’ etc. may be used herein to distinguish elements from one another. These ordinal numbers are merely used to distinguish the same or similar elements from one another, and meanings of the terms are not to be construed as being limited by the use of ordinal numbers. For example, use orders or arrangement orders of elements combined with these ordinal numbers are not limited by numbers thereof. The ordinal numbers may be redisposed with one another.

Hereinafter, embodiments of the present disclosure will be described in detail with reference to the accompanying drawings. However, the embodiments may be modified in various manners, and the scope is not limited to the embodiments described below. Furthermore, the technology disclosed in this specification may be applied to the components of the embodiments described below, all or part of the embodiments may be selectively combined and configured so that various modifications may be made.

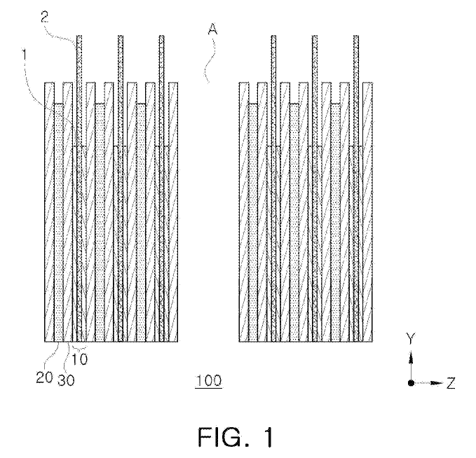

FIG. 1 is a cross-sectional view illustrating an electrode assembly according to an embodiment of the present disclosure.

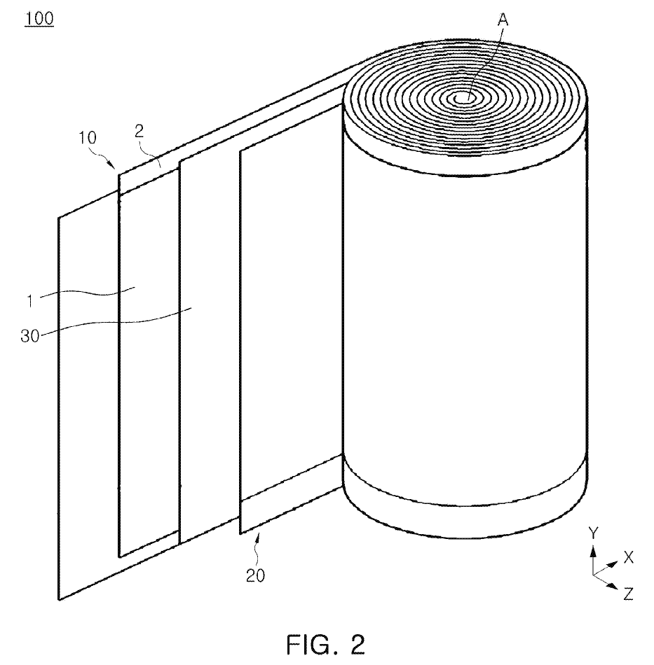

FIG. 2 is a perspective view illustrating an electrode assembly according to an embodiment of the present disclosure.

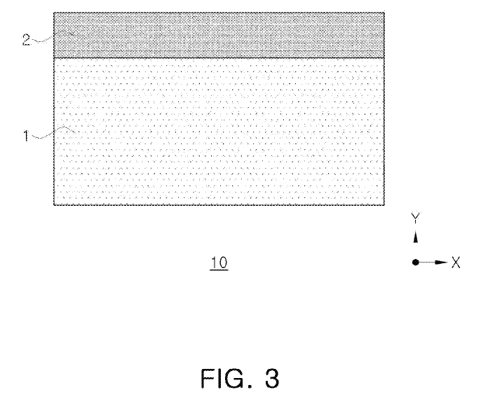

FIG. 3 is a plan view illustrating a configuration of a positive electrode according to an embodiment of the present disclosure, viewed in the thickness direction.

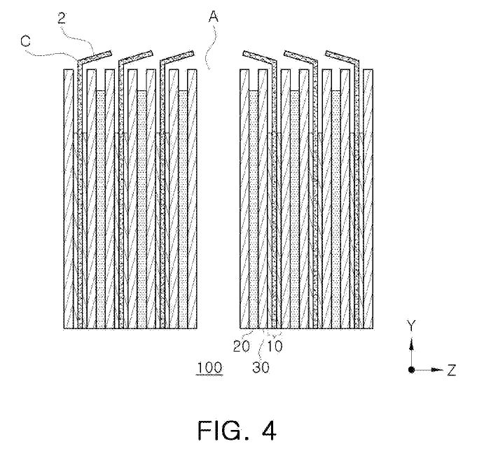

FIG. 4 is a cross-sectional view illustrating a configuration of a positive electrode uncoated portion of the electrode assembly of FIG. 1, bent radially toward the winding center.

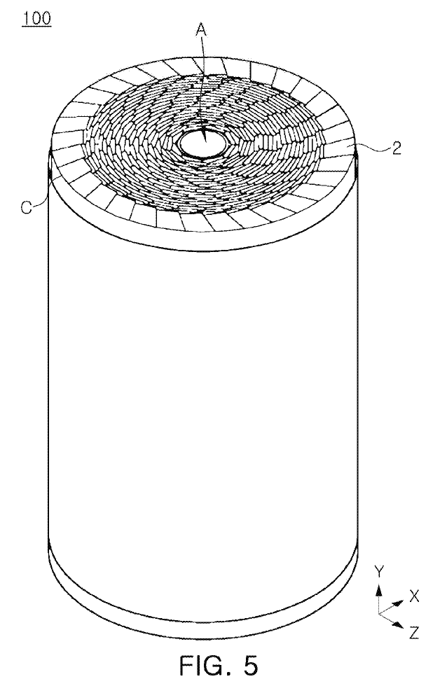

FIG. 5 is a perspective view illustrating a configuration of the positive electrode uncoated portion of the electrode assembly of FIG. 4, bent radially toward the winding center.

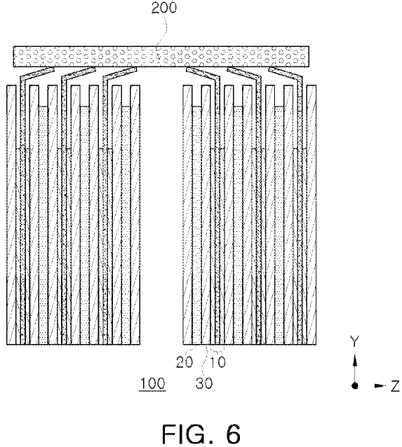

FIG. 6 is a cross-sectional view illustrating a configuration in which a positive electrode current collector is connected to the bent positive electrode uncoated portion of the electrode assembly of FIG. 4.

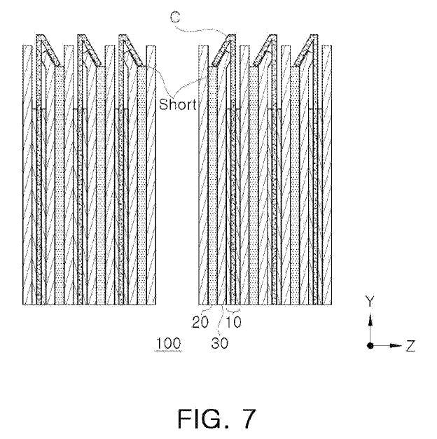

FIG. 7 is a cross-sectional view illustrating a configuration in which an internal short circuit occurs in an electrode assembly according to an embodiment of the present disclosure.

### Electrode Assembly

Referring to FIG. 1, an electrode assembly 100 according to an embodiment may include a positive electrode 10, a negative electrode 20, and a separator 30 interposed therebetween in the thickness direction Z. Furthermore, the electrode assembly may have a structure wound in the length direction X around a winding center (A), as illustrated in FIG. 2. Specifically, the electrode assembly 100 may be a jelly-roll type assembly in which the positive electrode 10, the negative electrode 20, and the separator 30 interposed therebetween are alternately stacked and wound into a roll.

The positive electrode 10 and the negative electrode 20 are not particularly limited. For example, the positive electrode 10 may include a positive electrode current collector and a positive electrode composite layer 1 disposed on at least one surface of the positive electrode current collector and including a positive electrode active material. The negative electrode 20 may include a negative electrode current collector and a negative electrode composite layer disposed on at least one surface of the negative electrode current collector and including a negative electrode active material.

The positive electrode active material and the negative electrode active material are not particularly limited. For example, the positive electrode active material may include at least one of a lithium transition metal oxide and a lithium metal phosphate, and the negative electrode active material may include at least one selected from the group consisting of carbon-based materials, such as crystalline carbon, amorphous carbon, carbon composites, and carbon fibers; lithium metal; lithium alloys; silicon-containing materials, and tin-containing materials.

The components of the positive electrode current collector and the negative electrode current collector are not particularly limited. For example, the positive electrode current collector and the negative electrode current collector may each be a plate or foil including one or more of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), and alloys thereof. In some embodiments, the positive electrode current collector may be aluminum foil (Al-foil), and the negative electrode current collector may be copper foil (Cu-foil).

The thicknesses of the positive electrode current collector and the negative electrode current collector are not particularly limited. For example, the thicknesses of the positive electrode current collector and the negative electrode current collector may each range from 0.1μm to 50μm.

As illustrated in FIGS. 1 to 3 , the positive electrode current collector may include a positive electrode uncoated portion 2, which is a portion in which a positive electrode composite layer 1 is not formed on the surface thereof. The positive electrode uncoated portion 2 may protrude from one end portion of the electrode assembly 100 in the width direction Y. Furthermore, the negative electrode current collector may include a negative electrode uncoated portion, which is a portion in which a negative electrode composite layer is not formed on the surface thereof, and the negative electrode uncoated portion may protrude from the other end portion of the electrode assembly 100 in the width direction Y.

The separator 30 is not particularly limited. For example, the separator 30 may include a porous polymer film made of a polyolefin polymer, such as an ethylene homopolymer, a propylene homopolymer, an ethylene/butene copolymer, an ethylene/hexene copolymer, or an ethylene/methacrylate copolymer. Furthermore, the separator may include a nonwoven fabric formed from high melting-point glass fibers, polyethylene terephthalate fibers, or the like.

Meanwhile, referring to FIG. 4, in the electrode assembly 100, the positive electrode uncoated portion 2 may be bent from a predetermined bend point C through a flattening process. Specifically, as illustrated in FIG. 5, the positive electrode uncoated portion 2 in the electrode assembly may be bent radially toward the winding center (A) at the predetermined bend point C.

The positive electrode uncoated portion 2 folded through the flattening process may be in contact with and connected to the positive electrode current collector 200. Specifically, as illustrated in FIG. 6, the positive electrode current collector 200 may be disposed on the bent positive electrode uncoated portion 2 and then electrically connected to the positive electrode uncoated portion 2 through a pressing and welding process.

In this regard, as illustrated in FIG. 7, in the electrode assembly 100 according to an embodiment, during the process of bending the positive electrode uncoated portion 2 to connect the positive electrode uncoated portion 2 to the positive electrode current collector 200, the positive electrode uncoated portion 2 may be excessively bent. Specifically, if the pressure applied during the flattening process is high, the positive electrode uncoated portion 2 may be excessively bent, resulting in an internal short-circuit phenomenon in which the negative electrode and the positive electrode uncoated portion come into contact.

If such an internal short circuit occurs, the internal temperature of the secondary battery including the electrode assembly 100 may rapidly rise, potentially leading to problems, such as a fire or explosion. In this regard, the electrode assembly 100 according to another embodiment of the present disclosure may have a structure capable of suppressing the aforementioned problems.

Specifically, the electrode assembly 100 may include the positive electrode 10, the negative electrode 20, and the separator 30 interposed therebetween in the thickness direction Z. The electrode assembly may have a structure wound in the length direction X around the winding center (A). The positive electrode may include the positive electrode uncoated portion 2 protruding from one width-directional end portion. The electrode assembly may include a first adhesive layer F1 and a second adhesive layer F2 at one width-directional end portion. The first adhesive layer may be disposed between the positive electrode uncoated portion and the separator, and the second adhesive layer may be disposed between one width-directional end portion of the negative electrode and the separator.

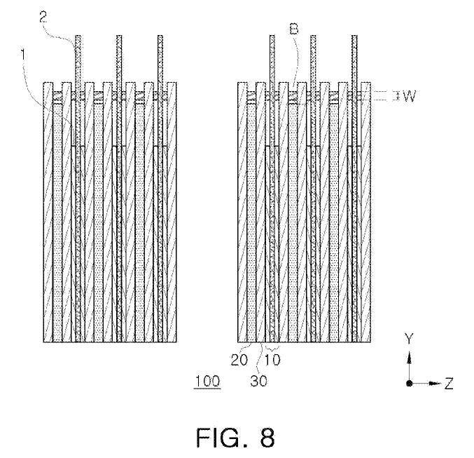

The electrode assembly 100 may have a structure of preventing the positive electrode uncoated portion 2 from being excessively bent, thereby suppressing an internal short circuit occurring during the flattening process, in which the positive electrode uncoated portion contacts the negative electrode. The embodiment will now be described in detail with reference to FIGS. 8 to 10.

FIG. 8 is a cross-sectional view illustrating a configuration in which a heat-fusible binder is applied to one width-directional end portion of the electrode assembly of FIG. 1.

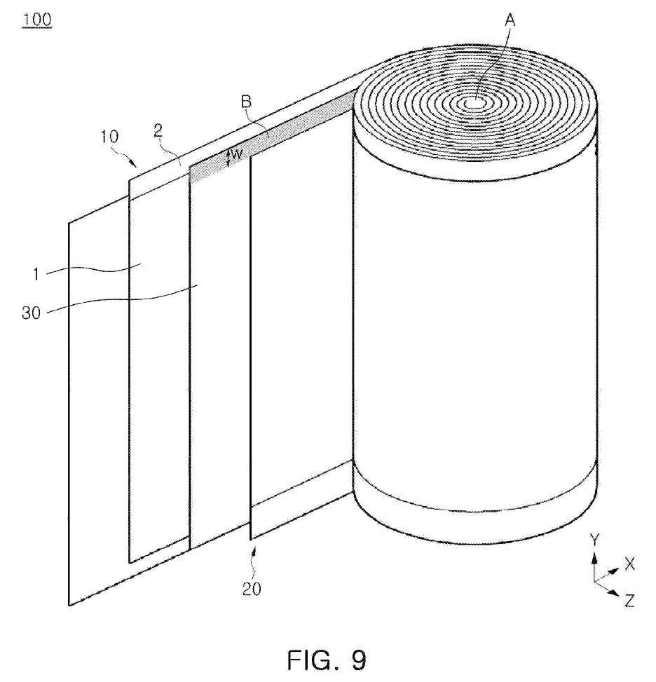

FIG. 9 is a cross-sectional view illustrating a configuration in which a heat-fusible binder is applied to the electrode assembly of FIG. 2.

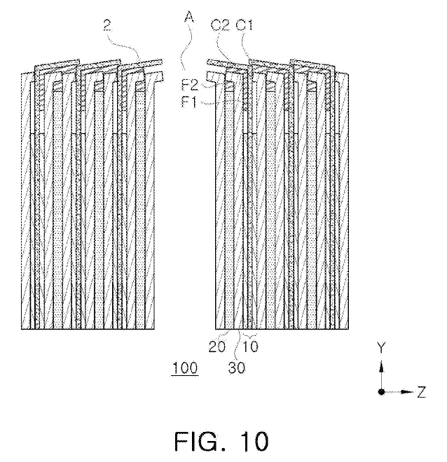

FIG. 10 is a cross-sectional view illustrating a configuration in which a positive electrode uncoated portion of the electrode assembly of FIG. 8 is bent radially toward the winding center.

Referring to FIGS. 8 and 9, in an embodiment, a heat-fusible binder B may be applied to one width-directional (Y) end portion of the electrode assembly 100 according to an embodiment. Specifically, the heat-fusible binder B may be applied to one width-directional (Y) end portion of the separator 30 in the electrode assembly 100.

The heat-fusible binder B may bond the positive electrode uncoated portion 2, the negative electrode 20, and the separator 30 to each other through heat fusion at a predetermined temperature or higher. In some embodiments, the heat-fusible binder may be heated prior to or during the flattening process to form an adhesive layer. Specifically, referring to FIG. 10 , the first adhesive layer F1 may be formed between the positive electrode uncoated portion 2 bent radially toward the winding center (A) by the flattening process and the separator 30, and the second adhesive layer F2 may be formed between the separator 30 and one width-directional (Y) end portion of the negative electrode 20.

If the electrode assembly 100 has a structure in which only the separators disposed on both sides of the negative electrode 20 are bonded together, the separator 30 may be damaged or the bond between the separators may be broken during the flattening process, thereby potentially preventing an internal short circuit.

In contrast, when the electrode assembly 100 has a structure in which the positive electrode uncoated portion 2, the negative electrode 20, and the separator 30 are all bonded together, excessive bending of the positive electrode uncoated portion 2 during the flattening process may be prevented, thereby protecting the negative electrode and separator from damage and suppressing an internal short circuit.

In some embodiments, the electrode assembly 100 may have a structure in which one width-directional (Y) end portion of the negative electrode 20 is surrounded by the second adhesive layer F2 and separators 30 disposed on both sides of the negative electrode. In this case, even if the positive electrode uncoated portion 2 is excessively bent during the flattening process, contact between the negative electrode 20 and the positive electrode uncoated portion 2 may be more effectively blocked.

The type of the heat-fusible binder B is not particularly limited, as long as it may bond the positive electrode 2, negative electrode 20, and separator 30 to each other through heat fusion at a predetermined temperature or higher. For example, the first adhesive layer F1 and the second adhesive layer F2 may each include at least one heat-fusible binder selected from the group consisting of polyvinylidene difluoride (PVDF), polyacrylonitrile (PAN), polybutylacrylate (PBA), polyethylhexylacrylate (PHEA), and polyacrylamide (PAAm).

As illustrated in FIG. 10, during the flattening process, one width-directional (Y) end portion of the positive electrode uncoated portion 2 and one width-directional (Y) end portion of the separator 30 may be bent radially toward the winding center (A) from a predetermined bend point. Specifically, the positive electrode uncoated portion 2 may have a structure radially bent toward the winding center (A) of the electrode assembly from a predetermined first point C1, and the separator 30 may have a structure radially bent toward the winding center (A) of the electrode assembly from a predetermined second point C2.

The bent points of the positive electrode uncoated portion 2 and the separator 30 may vary depending on the design of the electrode assembly 100. In some embodiments, the bent point of the positive electrode uncoated portion 2 may be located further outwardly in the width direction Y from the electrode assembly 100 than the bent point of the separator 30. Specifically, as illustrated in FIG. 10 , the first point C1 may be located further outwardly in the width direction Y from the electrode assembly 100 than the second point C2.

### Method of Manufacturing Electrode Assembly

According to an embodiment, a method of manufacturing the electrode assembly 100 includes assembling the positive electrode 10, the negative electrode 20, and the separator 30 interposed therebetween in the thickness direction Z to form an electrode assembly; applying the heat-fusible binder B to one width-directional (Y) end portion of the electrode assembly; winding the electrode assembly, to which the heat-fusible binder has been applied, around the winding center (A) in the length direction X; and heating the heat-fusible binder to form the first adhesive layer F1 and the second adhesive layer F2 on one width-directional (Y) end portion of the electrode assembly.

The positive electrode 10 includes the positive electrode uncoated portion 2 protruding from one width-directional (Y) end portion, the first adhesive layer F1 is disposed between the positive electrode uncoated portion 2 and the separator 30, and the second adhesive layer F2 is disposed between one width-directional (Y) end portion of the negative electrode 20 and the separator 30.

Specifically, when applying the heat-fusible binder B, the heat-fusible binder may be applied to cover one width-directional (Y) end portion of the separator 30. The method of applying the heat-fusible binder is not particularly limited. For example, the heat-fusible binder may be applied by spray coating.

In some embodiments, an application width W of the heat-fusible binder may be 2 to 10mm. Specifically, as illustrated in FIG. 9, the application width W of the heat-fusible binder may refer to a coating width of the heat-fusible binder B applied in the length direction X of the electrode assembly to one width-directional (Y) end portion of each of the positive electrode uncoated portion 2, the negative electrode 20, and the separator 30.

If the application width W of the heat-fusible binder is less than 2mm, the adhesive layer may not be properly formed. If the application width W of the heat-fusible binder exceeds 10mm, the resistance of the final completed cell may increase, resulting in deteriorated battery performance.

In some embodiments, the method of manufacturing the electrode assembly 100 may further include bending the positive electrode uncoated portion 2 and the separator 30 at the predetermined bend point C. Specifically, one width-directional (Y) end portion of the positive electrode uncoated portion 2 and the separator 30 may be bent radially toward the winding center (A) at the predetermined bend point C through a flattening process.

Accordingly, as illustrated in FIG. 10, the positive electrode uncoated portion 2 may have a structure bent radially toward the winding center (A) of the electrode assembly at the predetermined first point C1, and the separator 30 may have a structure bent radially toward the winding center (A) of the electrode assembly at the predetermined second point C2.

According to the method of manufacturing the electrode assembly 100 of an embodiment, the heat-fusible binder B may be heated to first bond one width-directional (Y) end portion of each of the positive electrode uncoated portion 2, the negative electrode 20, and the separator 30, and thereafter, the positive electrode uncoated portion 2 and the separator 30 may be bent at the predetermined bend point C.

According to the method of manufacturing the electrode assembly 100 of another embodiment, the positive electrode uncoated portion 2 and the separator 30 may be bent at the predetermined bend point C without a separate heating operation, while the heat-fusible binder may be heated at the same time. Accordingly, bending of the positive electrode uncoated portion 2 and the separator 30 may be performed simultaneously with the heating of the heat-fusible binder B.

Specifically, in the method of manufacturing the electrode assembly 100, the positive electrode uncoated portion 2 may be bent at the first point C1 and the separator 30 may be bent at the second point C2 using flattening equipment, such as a hot press, and at the same time, the first adhesive layer F1 may be formed using a heat-fusible binder included between the positive electrode uncoated portion 2 and the separator 30 and the second adhesive layer F2 may be formed using a heat-fusible binder included between the separator 30 and one width-directional (Y) end portion of the negative electrode 20.

In this case, the bending of the positive electrode uncoated portion 2 and the formation of the adhesive layer may be performed simultaneously during the flattening process, thereby enabling the production of the electrode assembly 100 having a structure capable of suppressing internal short circuits with excellent processability.

In some embodiments, a heating temperature of the heat-fusible binder B may be 110 to 130° C. If the heating temperature of the heat-fusible binder B exceeds 130° C, the separator may shrink due to heat, resulting in damage to the separator. If the temperature is lower than 110° C, the crosslinking and crystallization of the binder may be impaired, preventing the proper formation of an adhesive layer.

### Cylindrical Secondary Battery

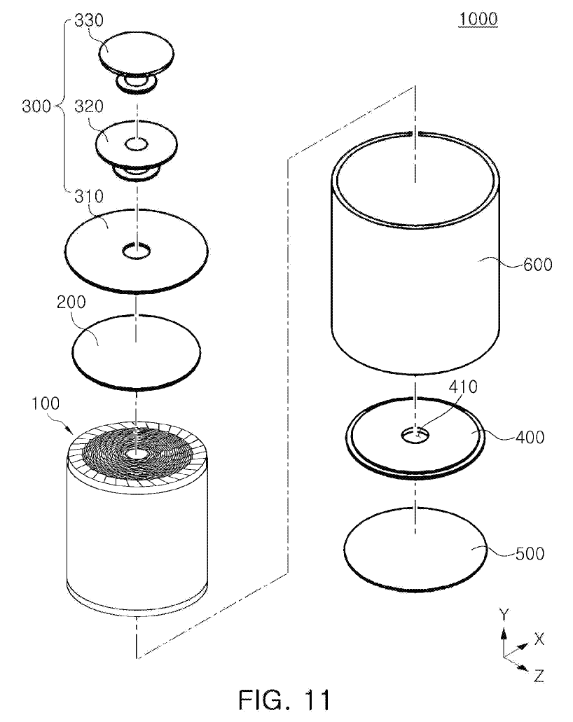

A cylindrical secondary battery 1000 according to an embodiment may include the electrode assembly 100 according to any one of the embodiments described above. Specifically, the electrode assembly 100 included in the cylindrical secondary battery 1000 may include the positive electrode 10, the negative electrode 20, and the separator 30 interposed therebetween in the thickness direction Z and is an electrode assembly wound in the length direction X based on the winding center (A). The positive electrode may include the positive electrode uncoated portion 2 protruding from one width-directional (Y) end portion, and the electrode assembly may include the first adhesive layer F1 and the second adhesive layer F2 at one width-directional (Y) end portion. The first adhesive layer may be disposed between the positive electrode uncoated portion and the separator, and the second adhesive layer may be disposed between one width-directional (Y) end portion of the negative electrode and the separator. Hereinafter, the cylindrical secondary battery 1000 will be described in detail with reference to FIG. 11.

FIG. 11 is an exploded perspective view illustrating a cylindrical secondary battery according to an embodiment of the present disclosure.

Referring to FIG. 11, the cylindrical secondary battery 1000 may include the electrode assembly 100, a positive electrode current collector 200, a positive electrode cap 300, a negative electrode current collector 400, a negative electrode cap 500, and a battery case 600.

In the cylindrical secondary battery 1000, the positive electrode uncoated portion 2 located at the upper portion of the electrode assembly 100 may be covered with the positive electrode current collector 200, and the negative electrode uncoated portion located at the lower portion may be covered with the negative electrode current collector 400. Specifically, the positive electrode current collector 200 and the negative electrode current collector 400 may each have a circular plate shape.

The positive electrode current collector 200 may be in contact with at least a portion of the positive electrode uncoated portion 2 and electrically connected thereto, and the negative electrode current collector 400 may be in contact with at least a portion of the negative electrode uncoated portion and electrically connected thereto. In this case, the positive electrode current collector 200 and the negative electrode current collector 400 may be welded to the positive electrode uncoated portion 2 and the negative electrode current collector 400, respectively.

In some embodiments, the positive electrode current collector 200 and the negative electrode current collector 400 may include the same material as those of the positive electrode current collector and the negative electrode current collector, respectively. For example, the positive electrode current collector 200 may include aluminum (Al), and the negative electrode current collector 400 may include copper (Cu).

The battery case 600 may be a cylindrical or column-shaped case with an internal space capable of accommodating the electrode assembly 100 and open at the upper and lower portions thereof in the width direction Y. The electrode assembly 100 may be inserted into the battery case 600 through the open upper portion. The upper portion of the battery case 600 may be sealed with the positive electrode cap 300, and the lower portion of the battery case 600 may be sealed with the negative electrode cap 500.

The battery case 600 may include an electrically conductive material. For example, the battery case 600 may include a metal, such as nickel-plated steel, stainless steel, or aluminum.

The positive electrode cap 300 may seal the open upper portion of the battery case 600. For example, the positive electrode cap 300 may be coupled to the upper portion of the battery case 600 to seal the open upper portion of the battery case 600. The method of sealing the upper portion of the battery case 600 is not particularly limited. For example, the positive electrode cap 300 may be coupled to the battery case 600 by laser welding to seal the upper portion.

The positive electrode cap 300 may include a positive electrode plate 310, a positive electrode terminal 320, and a gasket 330.

The positive electrode plate 310 may cover the open upper portion of the battery case 600. For example, the positive electrode plate 310 may have a circular disk shape. The perimeter of the positive electrode plate 310 and the upper portion of the battery case 600 may have corresponding shapes on their facing surfaces so that they are coupled together. The positive electrode plate 310 may have an edge welded while being coupled to the open upper portion of the battery case 600. A hole may be formed in the center of the positive electrode plate 310 into which the positive electrode terminal 320 and the gasket 330 may be inserted.

The positive electrode terminal 320 may be in contact with and electrically connected to the positive electrode current collector 200. For example, the lower portion of the positive electrode terminal 320 may be electrically connected to the positive electrode current collector 200 by welding. The upper portion of the positive electrode terminal 320 may be exposed externally through the hole in the positive electrode plate 310. Accordingly, the positive electrode terminal 320 may be electrically connected to the electrode assembly 100 and transmit electrical energy externally.

The gasket 330 may electrically insulate the positive electrode terminal 320 and the positive electrode plate 310. Specifically, the gasket 330 may include an insulator and may be disposed between the positive electrode terminal 320 and the positive electrode plate 310 to seal the space between the two components. In some embodiments, the positive electrode terminal 320 and the positive electrode plate 310 may each be coated with an insulating layer to ensure insulation between the two components. Accordingly, the gasket 330 may be omitted in the above embodiments.

In some embodiments, the negative electrode current collector 400 may include an electrolyte injection port 410. The electrolyte injection port 410 may be a hole formed to inject electrolyte. With the negative electrode current collector 400 connected to the negative electrode uncoated portion, the electrolyte may be injected into the battery case 600 through the electrolyte injection port 410.

The electrolyte may include an organic solvent and a lithium salt.

The organic solvent serves as a medium through which ions involved in the electrochemical reaction of the battery may move, and is not particularly limited. For example, a carbonate-based, ester-based, ether-based, ketone-based, alcohol-based, or aprotic solvent, may be used as the electrolyte either singly or in a mixture of two or more.

The lithium salt is dissolved in the organic solvent and acts as a source of lithium ions within the battery. The lithium salt enables the basic operation of a lithium secondary battery and promotes the movement of lithium ions between the positive and negative electrodes, and is not particularly limited.

The negative electrode cap 500 may seal the open lower portion of the battery case 600. In some embodiments, the negative electrode cap 500 may have a circular plate shape and may be welded to the open lower portion of the battery case 600. Specifically, the portion in which the perimeter of the negative electrode cap 500 and the battery case 600 meet may be welded.

According to an embodiment of the present disclosure, contact between the positive electrode uncoated portion and the negative electrode may be prevented during the manufacturing process of the cylindrical secondary battery.

According to another embodiment of the present disclosure, the manufacturing process of the cylindrical secondary battery may be improved.

According to an embodiment of the present disclosure, the number of components in the cylindrical secondary battery may be reduced.

Only specific examples of implementations of certain embodiments are described. Variations, improvements and enhancements of the disclosed embodiments and other embodiments may be made based on the disclosure of this patent document.

What is claimed is:

1. An electrode assembly including a positive electrode, a negative electrode, and a separator interposed therebetween in a thickness direction and wound in a length direction with respect to a winding center, wherein
the positive electrode includes a positive electrode uncoated portion protruding at one width-directional end portion,
the electrode assembly includes a first adhesive layer and a second adhesive layer at one width-directional end portion,
the first adhesive layer is disposed between the positive electrode uncoated portion and the separator, and
the second adhesive layer is disposed between one width-directional end portion of the negative electrode and the separator.

2. The electrode assembly of claim 1, wherein the one width-directional end portion of the negative electrode of the electrode assembly is surrounded by the second adhesive layer and the separator disposed on both sides of the negative electrode.

3. The electrode assembly of claim 1, wherein the first adhesive layer and the second adhesive layer each include at least one heat-fusible binder selected from the group consisting of polyvinylidene difluoride (PVDF), polyacrylonitrile (PAN), polybutylacrylate (PBA), polyethylhexylacrylate (PHEA), and polyacrylamide (PAAm).

4. The electrode assembly of claim 1, wherein the positive electrode uncoated portion is bent radially toward a winding center of the electrode assembly at a predetermined first point.

5. The electrode assembly of claim 4, wherein the separator is bent radially toward the winding center of the electrode assembly at a predetermined second point.

6. The electrode assembly of claim 5, wherein the first point is located further outwardly in the width direction from the electrode assembly, as compared to the second point.

7. A method of manufacturing an electrode assembly, the method comprising:
assembling a positive electrode, a negative electrode, and a separator interposed therebetween in a thickness direction to form an electrode assembly;
applying a heat-fusible binder to one width-directional end portion of the electrode assembly;
winding the electrode assembly, to which the heat-fusible binder has been applied, in the length direction with respect to a winding center; and
heating the heat-fusible binder to form a first adhesive layer and a second adhesive layer at one width-directional end portion of the electrode assembly,
wherein the positive electrode includes a positive electrode uncoated portion protruding from one width-directional end portion,
the first adhesive layer is disposed between the positive electrode uncoated portion and the separator, and
the second adhesive layer is disposed between one width-directional end portion of the negative electrode and the separator.

8. The method of claim 7, wherein, when applying the heat-fusible binder, the heat-fusible binder is applied to cover one width-directional end portion of the separator.

9. The method of claim 7, wherein an application width of the heat-fusible binder is 2 to 10 mm.

10. The method of claim 7, further comprising bending the positive electrode uncoated portion and the separator at a predetermined bend point.

11. The method of claim 10, wherein the bending of the positive electrode uncoated portion and the separator is carried out simultaneously with heating of the heat-fusible binder.

12. The method of claim 7, wherein a heating temperature of the heat-fusible binder is 110 to 130°C.

13. A cylindrical secondary battery comprising the electrode assembly according to claim 1.
